(19) United States
(12) Patent Application Publication
(10) Pub. No.: US 2026/0309066 A1
(43) Pub. Date: Oct. 8, 2026

(54) PRESSURIZED SYSTEMS AND METHODS FOR PROVIDING A NEBULIZED CATALYST

(71) Applicant: John Dale Stansell, Gainesville, TX (US)

(72) Inventor: John Dale Stansell, Gainesville, TX (US)

(73) Assignee: JAKE VERNON LLC, Gainesville, TX (US)

(21) Appl. No.: 19/098,046

(22) Filed: Apr. 2, 2025

Related U.S. Application Data
(60) Provisional application No. 63/574,544, filed on Apr. 4, 2024.

(51) Int. Cl. F01N 3/20

(52) U.S. Cl. CPC F01N 3/2066; F01N 3/208; F01N 2610/1406; F01N 2610/1433; F01N 2900/1814

(57) ABSTRACT

A catalyst injection system includes a catalyst reservoir configured to hold a liquid catalyst. The catalyst reservoir has intake port and an output port. The output port is situated to connect to a turbocharger of an engine. A fluid passage is disposed between the intake port and the output port. A first pump is coupled to the catalyst reservoir and is configured to generate a gas flow through the fluid passage and out of the output port to the turbocharger. A nebulizer is coupled to the catalyst reservoir. The nebulizer is configured to nebulize the liquid catalyst into the gas flow prior to the gas flow reaching the turbocharger.

### CROSS-REFERENCE TO RELATED APPLICATIONS

This application claims benefit under 35 U.S.C. § 119(e) of U.S. Provisional Application having Ser. No. 63/574,544 filed Apr. 4, 2024, which is hereby incorporated by reference herein in its entirety.

### BACKGROUND

The embodiments herein relate generally to engine systems, and more particularly, to a pressurized systems and methods for providing a nebulized catalyst.

Previous engine systems introduce the catalyst post compressor/turbocharger stage. This process results in a variation of system pressure to overcome the first flow of gas pressure, resulting in inconsistent catalyst delivery. In other systems, a sparging method has been used for atomization and post turbo delivery locations.

Some post turbo systems had to overcome the turbo boost pressure. The need for a high pressure in the catalyst container to overcome the turbo boost pressure could lead to unneeded stress on the internal components.

### SUMMARY

In one aspect of the subject technology, a catalyst injection system is disclosed. The catalyst injection system includes a catalyst reservoir configured to hold a liquid catalyst. The catalyst reservoir has intake port and an output port. The output port is situated to connect to a turbocharger of an engine. A fluid passage is disposed between the intake port and the output port. A first pump is coupled to the catalyst reservoir and is configured to generate a gas flow through the fluid passage and out of the output port to the turbocharger. A nebulizer is coupled to the catalyst reservoir. The nebulizer is configured to nebulize the liquid catalyst into the gas flow prior to the gas flow reaching the turbocharger.

In another aspect, a method is disclosed. The method includes initiating a run cycle of gas flow to a turbocharger in an engine. A liquid catalyst is drawn into the gas flow. The liquid catalyst is nebulized into the gas flow prior to the gas flow reaching the turbocharger.

### BRIEF DESCRIPTION OF THE FIGURES

The detailed description of some embodiments of the present invention is made below with reference to the accompanying figures, wherein like numerals represent corresponding parts of the figures.

FIG. 1 is a partial, perspective top view of a catalyst injection system, according to an exemplary embodiment of the subject technology.

FIG. 2 is a front view of the catalyst injection system of FIG. 1 without the surrounding engine elements.

FIG. 3 is a top, perspective view of the catalyst injection system of FIG. 2.

FIG. 4 is a front, cross-sectional view taken along the line 4-4 of FIG. 1.

### DETAILED DESCRIPTION OF CERTAIN EMBODIMENTS

The word “exemplary” is used herein to mean “serving as an example or illustration.” Any aspect or design described herein as “exemplary” is not necessarily to be construed as preferred or advantageous over other aspects or designs.

### System Embodiment

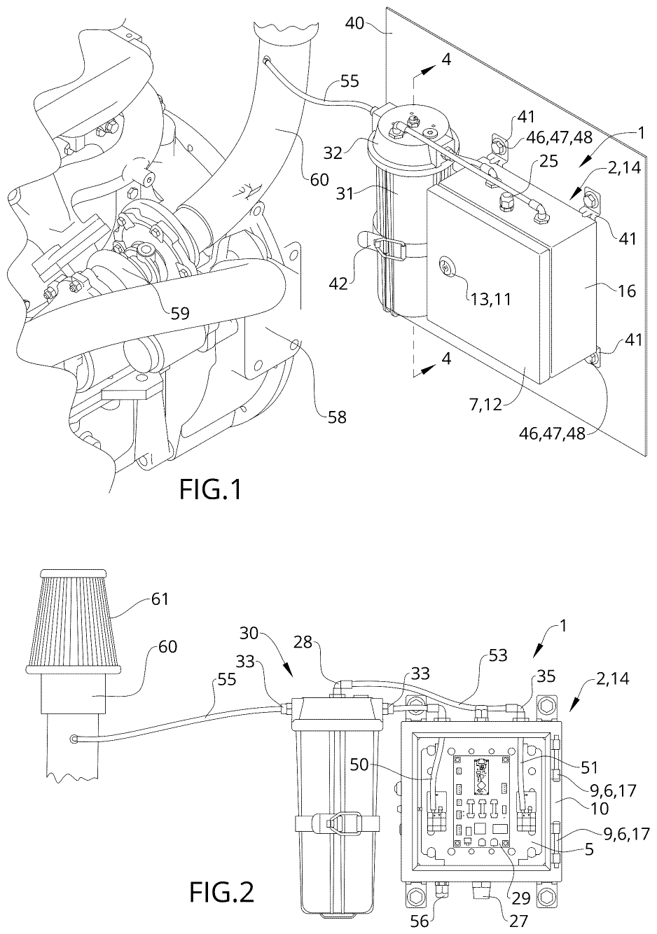

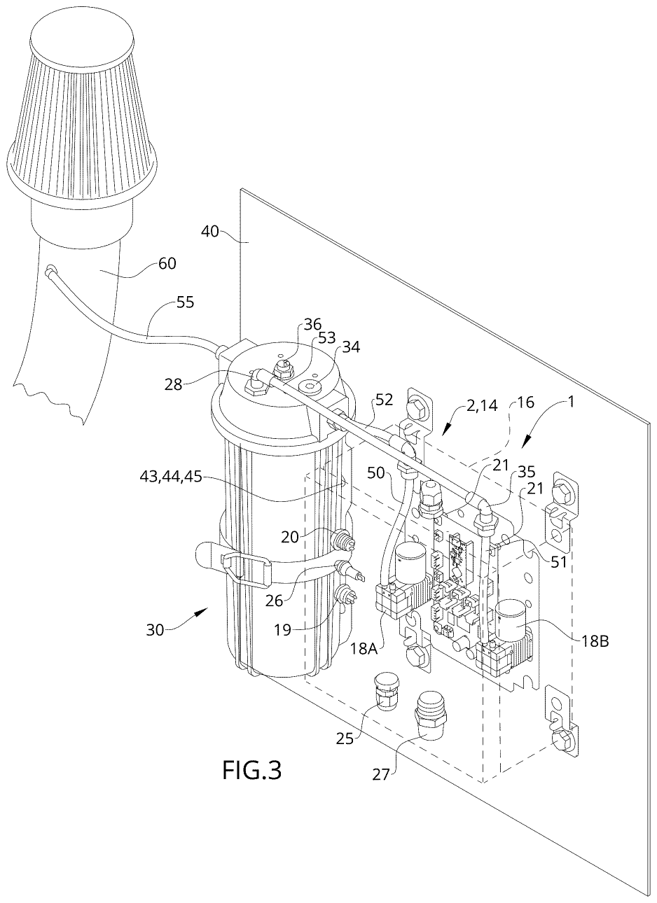

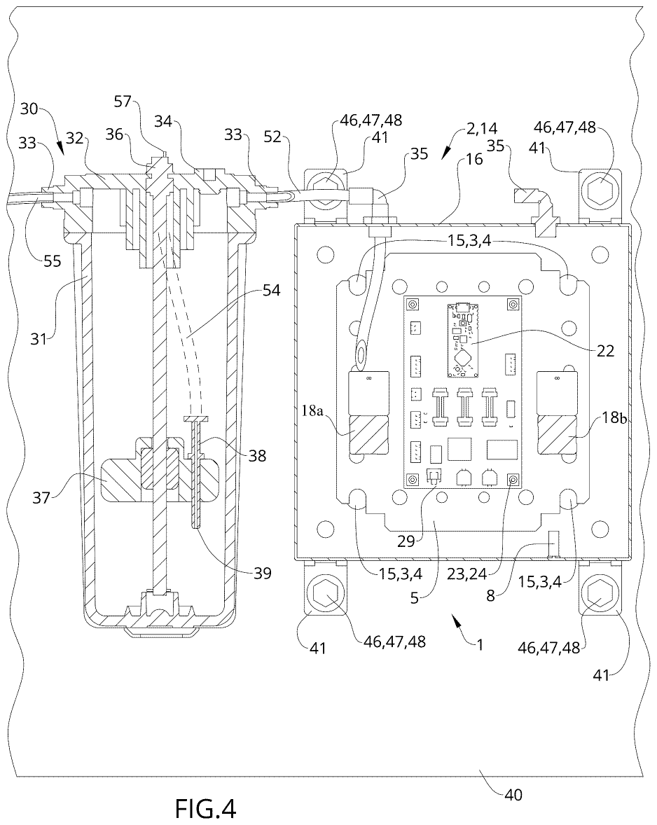

By way of example, and referring to the Figures, embodiments disclosed generally include a nebulizer for a catalyst which uses a method of nebulization on the catalyst. FIGS. 1-4 show a catalyst injection system 1 that delivers the catalyst within an engine system prior to the turbocharging stage promoting a siphoning effect in the catalyst container allowing for lower pressures and more consistent catalyst delivery. The catalyst injection system 1 and the catalyst reservoir assembly 30 may be mounted to a support surface 40 such as an engine wall compartment, via mounting assemblies 41 (which may include screws 46, washers 47, and nuts 48). The catalyst injection system 1 includes a control cabinet assembly 2 and a catalyst reservoir assembly 30 connected to the control cabinet assembly 2. The catalyst reservoir assembly 30 includes an outlet line 55 that delivers nebulized catalyst to a turbocharger 59 via an intake line 60. Control of the nebulized catalyst delivery is provided by a controller module 22 in the control cabinet assembly 2. Fluid flow from the control cabinet assembly 2 may be provided to the catalyst container reservoir 30 via a pressure cabinet to canister line 52 and a nebulizer cabinet to canister line 53. The line 53 may be connected to a bulkhead elbow 35 from the pressure pump 18 and to another bulkhead elbow 28 on the other end of the line 53 leading into the catalyst reservoir assembly 30.

### Catalyst Example

By way of example, some embodiments of the present disclosure include a method and composition for improving emissions and fuel efficiency in combustion chambers, the method comprising introducing a catalyst into a flame zone of a combustion chamber, such that the catalyst is held by gases in the flame zone prior to and during combustion of the fuel, thereby ionizing the catalyst prior to or during the combustion. The ionized catalyst may aid in more complete ignition and burning of present hydrocarbon fuels. The method may improve the efficiency in combustion chambers, oxidize carbon build up in the cylinder, and enhance fuel propagation during the combustion of the hydrocarbon fuels. In other words, use of the method and composition of the present disclosure may accelerate the fuel propagation during combustion of the hydrocarbon fuels.

The composition of the present disclosure may include a catalyst, which may be in liquid form, wherein the composition may comprise aluminum chloride and cerium (III) chloride, as main ingredients. In some embodiments, the composition may comprise one or more of deionized water, propylene glycol, lithium chloride, chloroplatinic acid, rhodium chloride, perrhenic acid, cerium (III) chloride, aluminum chloride, and a pH adjuster, such as lithium hydroxide or hydrochloric acid reagent.

In a particular embodiment, the composition may comprise about 70 to about 75 wt. %, such as about 71.8 wt. %, deionized water; about 25 to about 30 wt. %, such as about 27.6 wt. %, propylene glycol; about 0.1 to about 0.5 wt. %, such as about 0.39 wt. %, lithium chloride; about 0.05 to about 0.2 wt. %, such as about 0.11 wt. %, chloroplatinic acid; about 0.01 to about 0.02 wt. %, such as about 0.013 wt. %, rhodium chloride; about 0.01 to about 0.02 wt. %, such as about 0.018 wt. %, perrhenic acid; about 0.05 to about 0.1 wt. %, such as about 0.098 wt. %, cerium (III) chloride; about 0.005 to about 0.01 wt. %, such as about 0.0098 wt. % aluminum chloride, and a pH adjuster, such as lithium hydroxide or hydrochloric acid reagent.

To make the catalyst, deionized water and propylene glycol may be first mixed together for a period of, for example, about 10 minutes. Lithium chloride may be added to the mixture and dissolved, and the pH may be adjusted to from about 3.3 to about 3.7. Chloroplatinic acid may then be added and the solution may be mixed well, again maintaining the pH at about 3.3 to about 3.7. The rhodium chloride may then be added and the solution may be mixed, still maintaining the pH at about 3.3 to about 3.7. Perrhenic acid may be added next and the solution may be mixed, again while maintaining the pH at about 3.3 to about 3.7. The pH of the final solution may then be adjusted to 2.9 to 3.1 by adding lithium hydroxide or hydrochloric acid reagent to raise or lower the pH, respectively. To create the desired solution, the ingredients should be mixed in the above order. The resulting solution may be a clear, orange colored liquid with a specific gravity of 1.12, a density of 9.34 lbs. /gal, and a pH of 2.9-3.1.

A method of improving emissions and fuel efficiency in combustion chambers while simultaneously enhancing combustion of hydrocarbon fuels may comprise introducing a mixture of a composition comprising vaporous metallic compounds via a vaporous transport into the flame zone of a combustion chamber substantially homogeneously, such that the mixture is held by gases in the flame zone before and during the combustion of the fuel, and the mixture is thereby ionized prior to or during the combustion, and the ionized mixture of compounds contains about 10-30 parts per million of measure of fuel. In embodiments, the mixture of compounds may be introduced into the combustion chamber through an air flow through the turbocharger 59 and into the combustion chamber (not shown) that is housed within the engine 58. Alternatively, the mixture of compounds may be introduced into the combustion chamber through a mixture of fuel and air fed into the combustion chamber.

### Example Interrelationship of Individual System Elements

The control cabinet assembly 2 may house the controller module 22, a pressure pump 18, and a nebulizer pump 18. The controller module 22, pressure pump 18a, and nebulizer pump 18b may be mounted to the cabinet enclosure via a mounting plate 5 using a combination of a mounting plate nut 3, a mounting plate washer 4, and mounting plate stud 15.

The control cabinet assembly 2 may be an enclosure that includes a cabinet body frame 14 that incorporates a cabinet body 16 with a door frame 10, a door assembly 7, a door hinge 9 connecting a door panel 12 to the body 16 via hinge pin 6. The door assembly 7 may include a latch 11 for securing the door panel 12 to the frame 14 which may be closed by a lock 13. The control cabinet assembly 2 may include cable glands 25 on top and bottom walls of the frame 14 for connection of cables which are not shown herein for sake of illustration. The control cabinet assembly 2 may include an air filter 27 on the frame 14. The pressure pump 18 is configured to pull air from the outside of the frame 14 through the inlet of air filter 27 to supply the pressurized portion of the catalyst delivery from the catalyst reservoir assembly 30 to the first flow of gas. The impetus from pressure pump 18 provides the nebulized catalyst to the intake side of the turbocharger 59 just after the air cleaner assembly 61. The control cabinet assembly 2 may include a ground stud 8 grounding the cabinet assembly 2 to the support surface 40 or some other grounded element.

The controller module 22 may include a printed circuit board (PCB) 29 onto which a plurality of electrical components and circuits are installed. For example, the PCB 29 may include a control circuit and/or processor receiving electrical signals and supplying electrical signals to other parts of the system 1. The PCB 29 may include a voltage control circuit that controls voltage regulation among the system 1 various electrical components. The PCB 29 may include visible indicators such as red and green LEDs that signal a part's status. Control of the nebulizer 38 (described below) may be operated by connection to control of the PCB 29.

The catalyst reservoir assembly 30 may be mounted to the support surface 40 via a mounting fastener 42 (which may be a belt coupled to screws 43, washers 44, and nuts 45 fastened to the support surface 40). The catalyst reservoir assembly 30 includes a filter housing 31 with lid 32, a nebulizer 38, a float assembly 37, and a liquid level sensor/switch 36. Fluid input from the pressure cabinet to canister line 52 may connect to a straight fitting 33 on the intake side of the lid 32. Output from the catalyst reservoir assembly 30 may flow from another straight fitting 33 on the lid 32 on the output side. The catalyst reservoir assembly 30 is generally configured to pass fluid from the intake side to the output side of lid 32. Some embodiments may include a liquid level sensor 36 coupled to the lid 32 that is configured to detect the volume of fluid passing through the lid 32. For sake of illustration, the catalyst reservoir assembly 30 does not depict liquid catalyst but it should be understood that liquid catalyst is present within the filter housing 31. When the amount of liquid catalyst present within housing 31 falls below a threshold level, the liquid level sensor 36 may trigger a signal to the controller module 22 that the catalyst level is too low. Power to the liquid level sensor 36 and signaling to the controller module 22 may be provided by an electrical cable 57 connected to the controller module 22 in the control cabinet assembly 2.

Pressurized fluid may be supplied to the fluid passage in the catalyst reservoir assembly 30 via a pressure line 50 that is connected to the pressure pump 18 through the pressure cabinet to canister line 52. Fluid pressure may be supplied to the nebulizer 38 via a nebulizer supply line 51 that is connected to the nebulizer pump 18 via the nebulizer cabinet to canister line 53. The nebulizer 38 may include a tube 39 mounted to the float assembly 37. The float assembly 37 may be mounted to an interior wall of the filter housing 31. Output from the nebulizer 38 may be connected to the fluid flow in lid 32 via a nebulizer line 54.

In some embodiments, the catalyst reservoir assembly 30 includes a power switch 19 and a reset switch 20. In some embodiments, the catalyst reservoir assembly 30 includes a plug fitting 34 on the lid 32.

### Methodology and Example Operation

At engine start up, the system 1 will receive a voltage from any suitable source found on the engine components. This supplied voltage will supply power to the voltage regulator circuit integrated on the PCB Terminal Board 29 to regulate and distribute a constant 12-volt DC to components connected to the PCB Terminal Board 29. The 12-volt DC supplied to the PCB Terminal Board 29 will initiate the startup function of the system 1. The controller module 22 will read a signal supplied by the liquid level sensor 36 to determine if there is catalyst present in the catalyst reservoir assembly 30.

If catalyst is present in the catalyst reservoir assembly 30, the controller module 22 will start the run cycle. When the run cycle is on, the green LED may be turned on to indicate the system is running.

If no catalyst is present in the catalyst reservoir assembly 30, the controller module 22 may not start the run cycle. When the run cycle is off, the controller module 22 may illuminate the red LED to indicate the system is not running.

Once the run cycle is initiated the nebulizer pump 18 may run at full capacity (approximately 26 psi and 5.5 L/min) for approximately 2 minutes to purge/clear any foreign debris that may have settled in the line set. The nebulizer pump 18 will pull filtered air in through the external air filter assembly 27 into the nebulizer pump 18 and to the nebulizer 38. This process will cause a siphoning effect on the nebulizer 38 to pull the liquid catalyst up through pickup tube 39 portion of the nebulizer 38 to the nebulizing portion of the nebulizer 38. The air pressure supplied will nebulize the liquid catalyst to a vapor state.

After a pre-set time, for example, 2 minutes have passed, the controller module 22 may adjust the voltage to the nebulizer pump 18b using PWM (Pulse Width Modulization) via an input wire to control speed of nebulization. Pressure and flow rate of nebulized catalyst may be determined by the controller module 22 and may be dependent on engine size and fuel use rate, the parameters of which may be programmed into the controller module 22. This may be dictated by the fuel usage per hour. For example, an engine using 20 gallons of fuel per hour should have a nebulization and delivery rate at 1.5 milliliters per hour. This will be accomplished by adjusting the voltage with PWM. Nebulized catalyst will flow as vapor out of the catalyst reservoir assembly 30 through the catalyst output line 55 and into the intake line 60 of the turbocharger 59 just after the air cleaner assembly 61.

The turbocharger 59 of an engine 58 the system 1 is installed on, will aid in the siphoning of the catalyst from the catalyst reservoir assembly 30 and deliver the mixed first flow of air and nebulized catalyst into the air intake line 60 side of the turbocharger 59 and on to the combustion chamber. The first flow of air and mixed catalyst will then be mixed with the fuel particles in the combustion chamber.

Persons of ordinary skill in the art may appreciate that numerous design configurations may be possible to enjoy the functional benefits of the inventive systems. Thus, given the wide variety of configurations and arrangements of embodiments of the present invention the scope of the present invention is reflected by the breadth of the claims below rather than narrowed by the embodiments described above.

What is claimed is:

1. A catalyst injection system, comprising:
a catalyst reservoir configured to hold a liquid catalyst;
an intake port on the catalyst reservoir;
an output port coupled to the catalyst reservoir, wherein the output port is situated to connect to a turbocharger of an engine;
a fluid passage disposed between the intake port and the output port;
a first pump coupled to the catalyst reservoir, configured to generate a gas flow through the fluid passage and out of the output port to the turbocharger; and
a nebulizer coupled to the catalyst reservoir, wherein the nebulizer is configured to nebulize the liquid catalyst into the gas flow prior to the gas flow reaching the turbocharger.

2. The system of claim 1, further comprising a controller module coupled to the nebulizer and to the pump, wherein a flow rate of nebulized liquid catalyst into the gas flow is controlled by the controller module.

3. The system of claim 2, further comprising a liquid level sensor coupled to the controller module and to the catalyst reservoir and disposed to detect a fluid level of the liquid catalyst in the catalyst reservoir.

4. The system of claim 3, wherein the controller module is configured to run a flow cycle of the gas flow with nebulized catalyst when the liquid level sensor detects the liquid catalyst in the catalyst reservoir.

5. The system of claim 4, further comprising a first LED coupled to the controller module, wherein the first LED is illuminated when the controller module runs the flow cycle.

6. The system of claim 5, wherein the controller module is configured to not run a flow cycle of the gas flow with nebulized catalyst when the liquid level sensor does not detect the liquid catalyst in the catalyst reservoir.

7. The system of claim 6, further comprising a second LED coupled to the controller module, wherein the second LED is illuminated when the controller module does not run the flow cycle.

8. The system of claim 2, further comprising a second pump coupled to the nebulizer and configured to draw the liquid catalyst into the nebulizer for nebulization.

9. The system of claim 2, wherein the controller module is configured to control a flow rate of nebulized liquid catalyst dependent on a size of the engine.

10. A method, comprising:
initiating a run cycle of gas flow to a turbocharger in an engine;
drawing a liquid catalyst into the gas flow; and
nebulizing the liquid catalyst into the gas flow prior to the gas flow reaching the turbocharger.

11. The method of claim 10, further comprising determining a rate of nebulization of the liquid catalysts is dependent on a size of the engine.

12. The method of claim 11, wherein the rate of nebulization of the liquid catalysts is dependent on a fuel rate consumption of the engine.

13. The method of claim 10, further comprising determining whether a fluid level of the liquid catalyst is sufficient to initiate the run cycle.

14. The method of claim 13, further comprising:
illuminating an indicator to represent that a fluid level of the liquid catalyst is insufficient and
preventing an operation of the run cycle.
